(19) United States
(12) Patent Application Publication
(10) Pub. No.: US 2014/0067321 A1
(43) Pub. Date: Mar. 6, 2014

(54) SYSTEMS AND METHODS FOR MONITORING MACHINING OF A WORKPIECE

(71) Applicant: Schmitt Industries, Inc., Portland, OR (US)

(72) Inventor: Michael Detlef Zinngrebe, Ulm (DE)

(73) Assignee: Schmitt Industries, Inc., Portland, OR (US)

(21) Appl. No.: 14/017,653

(22) Filed: Sep. 4, 2013

Related U.S. Application Data
(60) Provisional application No. 61/697,604, filed on Sep. 6, 2012.

(51) Int. Cl. G04F 10/00

(52) U.S. Cl. CPC G04F 10/00
USPC 702/176

(57) ABSTRACT

A monitoring system may be used to monitor machining of a workpiece. In some embodiments, the monitoring system may use an acoustic emission sensor to measure acoustic emissions from the machining and generate an acoustic emission signal. The acoustic emission signal may be compared to a master signal using several techniques, such as a Multi-Zone Strategy method. The Multi-Zone Strategy method may comprise generating a plurality of zones of the measured signal and generating a plurality of zones of a master signal to create a plurality of measured and master signal levels and thresholds. A measured signal level for each zone may be compared to a master signal level for each zone to determine whether the measured signal level differs from the master signal level by no more a predetermined percentage, which acts as a threshold for triggering notification of out of tolerance zones.

### RELATED APPLICATIONS

This application claims priority to U.S. Provisional Patent Application with Ser. No. 61/697,604 filed on Sep. 6, 2012, and entitled “Systems and Methods for Monitoring Machining of a Workpiece,” which is hereby incorporated by reference herein in its entirety.

### TECHNICAL FIELD

This disclosure relates to systems and methods for monitoring machining of a workpiece.

### BRIEF DESCRIPTION OF THE DRAWINGS

FIGS. 1A-B are a side view and a zoomed view of a cylindrical grinding machine for machining a workpiece while monitoring the machining with an acoustic emission sensor.

FIGS. 2A-B are exemplary screen displays from a monitoring system while using a multi-zone monitoring strategy.

FIG. 3A is an exemplary screen display from the monitoring system while monitoring compliance with a lower limit using the Envelope Function method.

FIG. 3B is an exemplary screen display from the monitoring system while monitoring compliance with a lower limit using the Multi-Zone Strategy method.

FIG. 4 is an exemplary screen display for setting up the Multi-Zone Strategy method on the monitoring system.

FIG. 5 is an exemplary screen display for further setting up the Multi-Zone Strategy method on the monitoring system.

FIG. 6 is an exemplary screen display for setting parameters of measuring equipment, such as the acoustic emission sensor.

FIGS. 7A-B are flow diagrams of methods for creating master data in a learning mode and comparing a measured acoustic emission signal to the master data.

FIGS. 8A-C are exemplary screen displays from the monitoring system while setting up the monitoring system with the methods from FIGS. 7A-7B.

### DETAILED DESCRIPTION OF PREFERRED EMBODIMENTS

A machining tool may be used to machine a workpiece. Machining may include a form of manufacturing in which one or more material-working processes may utilize power-driven machine tools, such as saws, lathes, milling machines, grinding machines, grinding wheel dressing machines, stamping machines, drill presses, and the like. The material-working process may be used to physically remove material and/or reshape material to achieve a desired geometry. The machine tools may be used for dressing, grinding, turning, honing, drilling, milling, stamping, pressing, and/or the like. The workpiece may be a grinding wheel, a grinding machine dresser wheel, a grinding machine cutting wheel, a manufactured part, or the like. In some embodiments, a dressing wheel may dress a grinding wheel, which is in turn used for machining other workpieces. Each side of a grinding wheel may be machined by a dressing wheel.

Machining of a manufactured part, a grinding wheel, or both may be monitored. Machining may be monitored and/or controlled in any of several ways, such as monitoring acoustic emissions, power consumption, temperature, vibration, acceleration, torque, force, and/or the like. Appropriate sensors may be able to measure the values of these properties and produce a measured signal that shows changes in the properties over time. An acoustic emission sensor may be a piezoelectric sensor. A power sensor may measure current and/or power consumed by the machining tool. A temperature sensor may measure a temperature of a spindle bearing, a coolant flow strain, or the like. Some embodiments may comprise a plurality of sensors measuring one or more properties.

Machining a workpiece, such as a grinding machine dresser wheel, a grinding machine cutting wheel, a manufactured part, or the like, in a predetermined manner may be referred to as a process. Differences between a first measured signal produced when using a first process and a second measured signal produced when using a second process may indicate variations between the two processes and between the workpieces that result from each process. Adjustments to the machining process to ensure the measured signals remain within predetermined tolerances may allow for more precise machining of a workpiece, such as a grinding machine dresser wheel, a grinding machine cutting wheel, a manufactured part ground by the cutting wheel, or the like. A measured signal created through trial and adjustment may be referred to as a learned measured signal. A measured signal level that produces a desired workpiece may be referred to as a master signal level. Master signal levels may or may not be learned in some embodiments. A control process may be replicated using the mastered or learned measured signals produced from a within tolerance process. Thus, the measured signals may allow the process to be repeatable and reproducible and thereby may control the process within high tolerances.

In some embodiments, an Envelope Function may be used to define tolerances and monitor a process. A user may define a process time representing the duration of the process and define a master measured signal trace for that process. The user may then establish thresholds above and below the master or learned trace as upper and lower tolerances for the process. The thresholds may be produced arithmetically by adding or subtracting predetermined offsets to the master or learned trace. When a process is run, the amount of time a measured process signal is outside the thresholds may be measured by a monitoring system. If the amount of time outside the thresholds exceeds a predetermined amount of time, the monitoring system may indicate the process is out of tolerance by triggering a relay switch, displaying an indication to a user, and/or the like.

Under a Multi-Zone Strategy method, the process time may be subdivided into a plurality of contiguous time zones. In an embodiment, the plurality of contiguous time zones may not overlap and may not have gaps between them. The time zones may be selected to have an ultrahigh precision, which may be made possible by measuring time in a very precise manner. Each time zone may be mapped to a known, physical location and/or distance on the workpiece. Distance may be computed from time if a speed relative to the workpiece is known (e.g., a lateral speed across the workpiece during the process). Alternatively, distance may be expressed in units of time. The time/distance zones may be equal to each other in some embodiments. A size of each time/distance zone may be defined by the time period, number of zones, or the like.

A mean value of the master or learned trace over each time/distance zone, an average over each time/distance zone, a median value over each time/distance zone, and/or the like may be used to establish a plurality of master or learned signal levels for the corresponding plurality of time/distance zones. The measured process signal may be similarly divided into a plurality of measured signal levels. Each measured signal level may be compared to the corresponding master or learned signal level. If the measured signal level is outside one or more predetermined tolerance thresholds, the process may be considered out of tolerance for that time period/distance.

If more than a predetermined number of time periods/distances are out of compliance, a relay switch may be triggered, an indication may be displayed to a user, and/or the like. The predetermined number may be zero. Because a physical location corresponding to an out of tolerance time period may be known for the Multi-Zone Strategy method, the problem area on the workpiece may be easily and precisely located and controlled/corrected. The system and Multi-Zone Strategy method may provide sub-micron precision in the control of the master and intermediate process steps as well as in the final part. The ultrahigh precision of the Multi-Zone Strategy method (time/distance) monitoring, as well as its repeatability and reproducibility, may result in improved quality and savings of time and/or cost.

The embodiments may include various steps, which may be embodied in machine-executable instructions to be executed by a computer system. A computer system may comprise one or more general-purpose or special-purpose computers (or other electronic devices). Alternatively, the computer system may comprise hardware components that include specific logic for performing the steps or comprise a combination of hardware, software, and/or firmware.

A computer system may comprise a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, or a combination thereof.

Each computer system includes at least a processor and a memory; computer systems may also include various input devices and/or output devices. The processor may include one or more general-purpose central processing units (CPUs), graphic processing units (GPUs), or Digital Signal Processors (DSPs), such as Intel®, AMD®, Nvidia®, ATI®, TIC), or other “off-the-shelf” microprocessors. The processor may include a special-purpose processing device, such as ASIC, PAL, PLA, PLD, Field Programmable Gate Array (FPGA), or other customized or programmable device. The memory may include static RAM, dynamic RAM, flash memory, ROM, CD-ROM, disk, tape, or magnetic, optical, or other computer storage media. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

Embodiments may also be provided as a computer program product, including a machine-readable storage medium having stored thereon instructions that may be used to program a computer (or other electronic device) to perform processes described herein. The machine-readable storage medium may include, but is not limited to, hard drives, floppy diskettes, optical disks, CD-ROMs, DVD-ROMs, ROMs, RAMs, EPROMs, EEPROMs, magnetic or optical cards, tapes, solid-state memory devices, or other types of media/machine-readable media suitable for storing electronic instructions.

Suitable software to assist in implementing the invention is readily provided by those of skill in the pertinent art(s) using the teachings presented here and programming languages and tools, such as Java, Pascal, C++, C, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Several aspects of the embodiments described will be illustrated as software modules or components. As used herein, a software module or component may include any type of computer instruction or computer-executable code located within a memory device. A software module may, for instance, comprise one or more physical or logical blocks of computer instructions, which may be organized as a routine, a program, an object, a component, a data structure, etc., that performs one or more tasks or implements particular abstract data types.

In certain embodiments, a particular software module may comprise disparate instructions stored in different locations of a memory device, different memory devices, or different computers, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Much of the infrastructure that can be used according to the present invention is already available, such as general-purpose computers, computer programming tools and techniques, computer networks and networking technologies, and digital storage media.

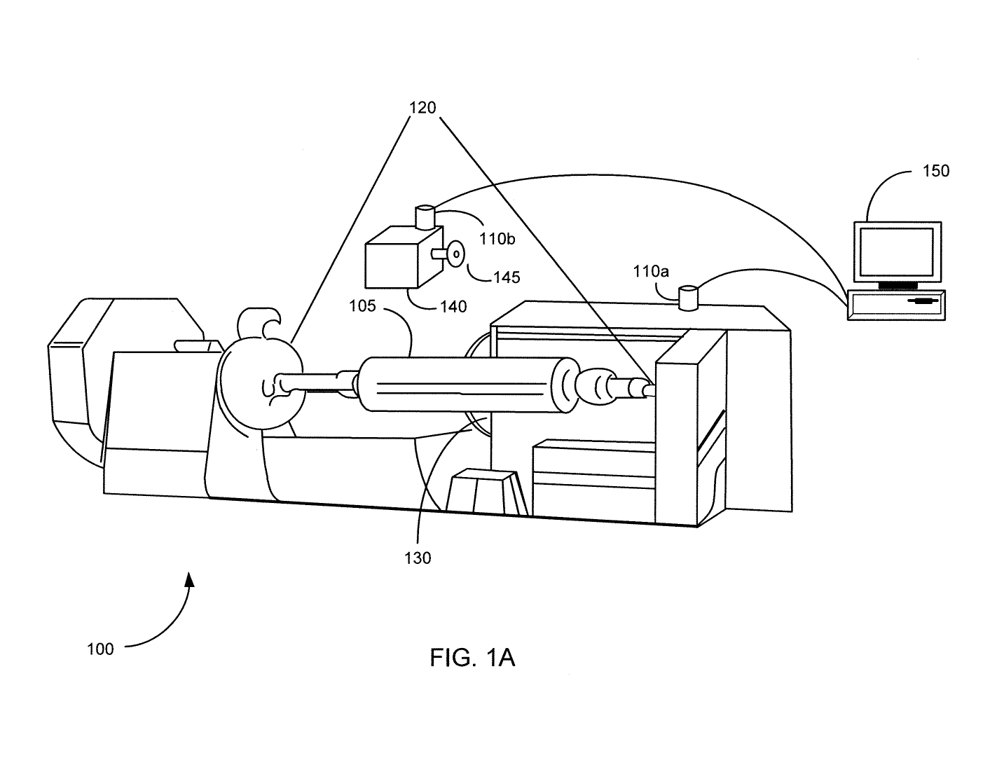

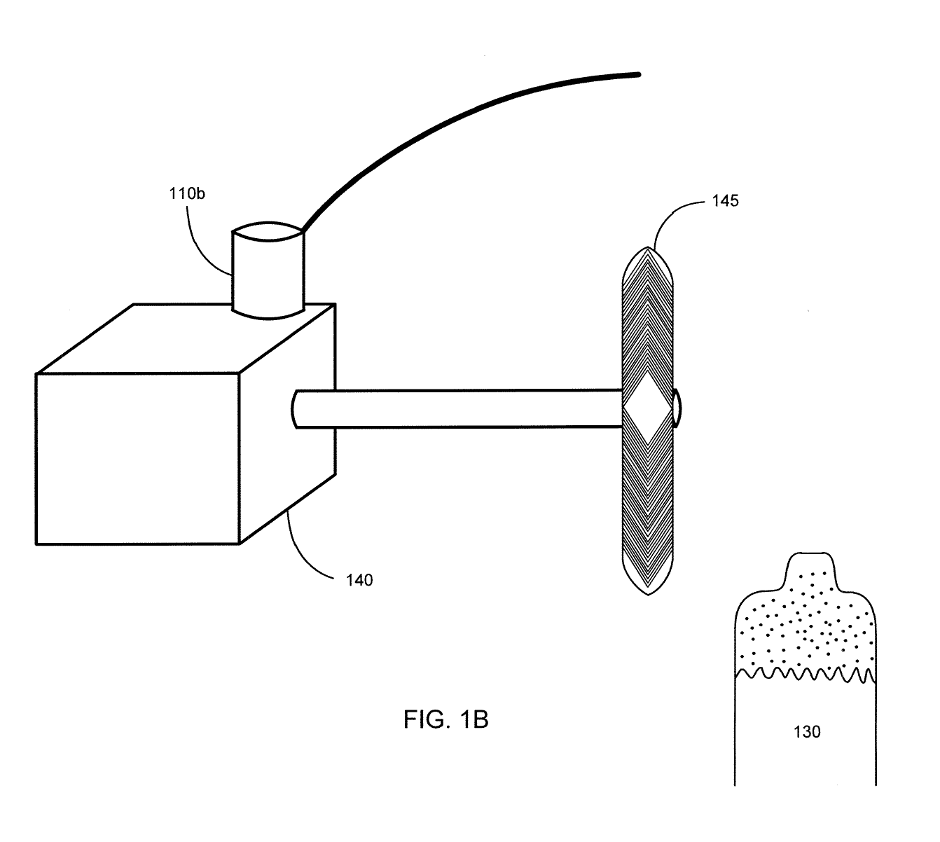

FIGS. 1A-B are a side view and a zoomed view of a cylindrical grinding machine 100 for machining a workpiece while monitoring the machining with acoustic emission sensors 110a-b. A manufactured part 105 may be held in place and rotated by centers 120. A grinding wheel 130 may also be rotated and may have an abrasive surface. In a grinding process, the grinding wheel 130 may be brought into contact with the manufactured part 105 to grind the surface of the manufactured part 105. The grinding wheel 130 may be able to remove layers of the manufactured part 105 with a precision of less than a micron. When the grinding wheel 130 contacts the manufactured part 105, the contact results in acoustic emissions that may be sensed by a first acoustic emission sensor 110a mounted on the cylindrical grinding machine 100.

The grinding wheel 130 may be dressed by a dresser 140 comprising a dressing wheel 145. The dresser 140 can be mounted directly onto the cylindrical grinding machine 100. In a dressing process, the dressing wheel 145 may be rotated against the grinding wheel 130 to reshape the grinding wheel 130 such that the grinding wheel 130 will be able to achieve a desired geometry of the manufactured part 105. When the dressing wheel 145 contacts the grinding wheel 130, this contact also results in acoustic emissions. A second acoustic emission sensor 110b mounted on the dresser unit 140 may sense acoustic emissions from the dressing of the grinding wheel 130.

The dressing wheel 145 may initially prepare the grinding wheel 130, so the outer periphery of the grinding wheel 130 is within desired tolerances. The grinding wheel 130 may be shaped so that it will grind the manufactured part 105 in a desired manner. The dressing wheel 145 may comprise an industrial diamond wheel configured to shape an abrasive wheel at a very high RPM. The grinding wheel 130 may comprise a material with a softer consistency than the dressing wheel 145 and may be shaped in a circumferential manner. It may take several dressings to prepare the grinding wheel 130. The dressing wheel 145 may be angularly adjusted to control the shaping of the grinding wheel 130. Monitoring by the second acoustic emission sensor 110b according to the methods discussed herein may improve control of the dressing wheel 145. The improved control may allow for very accurate dressing of the wheel into a desired shape that is repeatable and reproducible. The grinding wheel 130 may then be used to shape the manufactured part 105. The grinding of the manufactured part may be monitored by the first acoustic emission sensor 110a.

The acoustic emission sensors 110a-b may measure the amplitude of the acoustic emissions. Various types and styles of acoustic emission sensors may be utilized, such as fixed bolt-on type, rotational type, fluid acoustic emission sensors, and the like. The acoustic emission sensors 110a-b may be mounted in various locations, such as directly on the dresser 140, on a holder for the manufactured part 105, on a holder for a different kind of workpiece, or the like. In some embodiments, the acoustic emission sensors 110a-b may be piezoelectric sensors. Each acoustic emission sensor 110a-b may convert the amplitude of acoustic emissions into an acoustic emission signal comprising a voltage varying in proportion to the amplitude. Alternatively, each acoustic emission sensor 110a-b may sample the acoustic emissions to produce a digital acoustic emission signal comprising a plurality of digital samples representative of the acoustic emissions. The acoustic emission signal for each process then may be transmitted from the acoustic emission sensors 110a-b to a monitoring system 150.

The monitoring system 150 may be a computer system. It may input the acoustic emission signal and monitor whether the acoustic emission signal remains within predetermined thresholds. The monitoring system 150 may comprise an output device configured to inform a user of the current status. If the monitoring system 150 detects that the acoustic emission signal has exceeded the predetermined thresholds, it may trigger a relay switch, end the grinding, display an indication to the user, or the like.

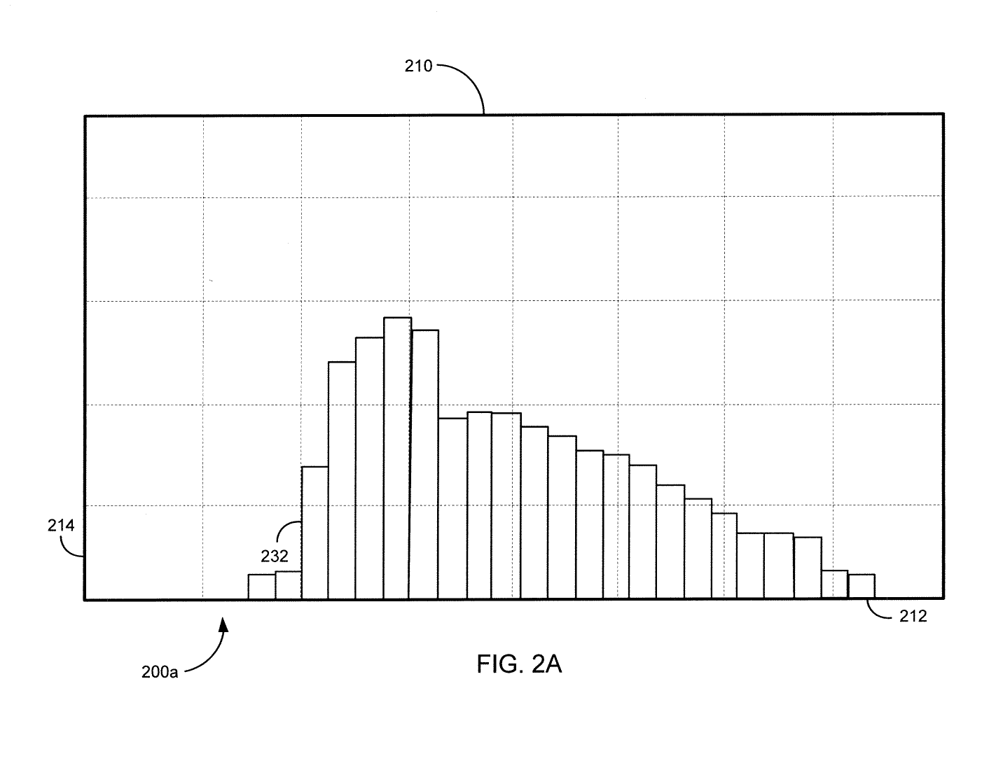

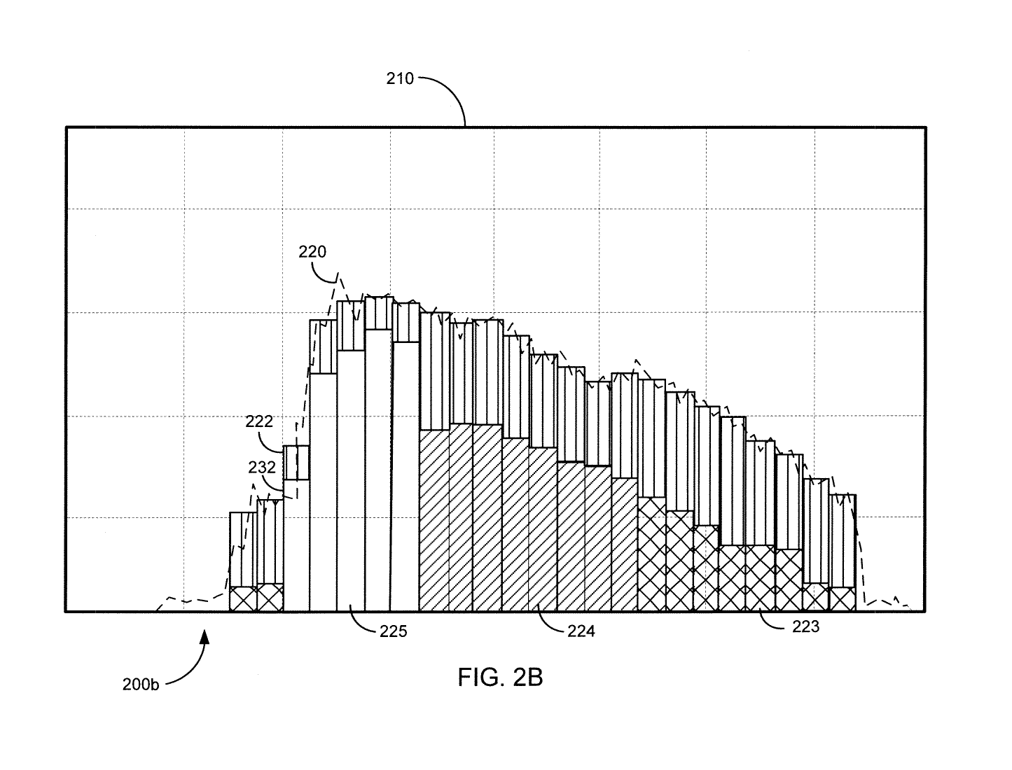

FIGS. 2A-B are exemplary screen displays 200a-b from the monitoring system 150 while using a multi-zone monitoring strategy. The screen displays 200a-b may comprise a graph 210. The graph 210 may comprise an x-axis 212 that represents time/distance and a y-axis 214 that represents amplitude, intensity, voltage, or the like. In some embodiments, the scale of the y-axis 214 may be a percentage of a maximum possible value. The screen displays may further comprise a plurality of master or learned signal levels 232 for a corresponding plurality of time/distance zones. The master or learned signal levels 232 may be depicted as rectangular bars with the width of each bar corresponding to a time/distance zone size and the height of each bar corresponding to a desired value for that time/distance zone. The width of the time/distance zones may be selected based on the precision desired. For example, the time/distance zones may be selected to be on the order of microns or sub-microns to provide a nearly continuous value for problem locations.

The screen display 200b may depict a measured acoustic emission signal 220 as a line on a graph 210. The screen display 200b may further depict a plurality of measured acoustic emission signal levels 222 generated using the Multi-Zone Strategy method. The plurality of measured acoustic emission signals levels 222 may be generated by integrating the measured acoustic emission signal 220 over each of a plurality of time/distance zones. If the measured acoustic emission signal level 222 for a time zone i is represented as AEL[i], then, in some embodiments, the measured acoustic emission signal level may computed according to:

$$\begin{matrix}AEL [ i ] = {\int }_{Δ {t}_{i}} AE ( t ) d t & ( 1 ) \\ AEL [ i ] = {\sum }_{j ∈ {n}_{i}} AE [ j ] & ( 2 )\end{matrix}$$

wherein equation (1) may be used for continuous time acoustic emission signals with AE representing the acoustic emission signal 220, t representing time/distance, and Δt, represents the time/distance during zone i, and wherein equation (2) may be used for discrete time acoustic emissions signals with j representing time/distance and nᵢ representing the set of samples in zone i. Alternatively, the measured acoustic emission signal levels may be computed as averages according to the formulas:

$$\begin{matrix}AEL [ i ] = \frac{1}{Δ {t}_{i }} {\int }_{Δ {t}_{i}} AE ( t ) d t & ( 3 ) \\ AEL ⌊ i ⌋ = \frac{1}{n} {\sum }_{j ∈ {n}_{i}} AE ⌊ j ⌋ & ( 4 )\end{matrix}$$

wherein equation (3) may be used for continuous time acoustic emission signals and wherein equation (4) may be used for discrete time acoustic emissions signals with n representing the number of samples in the set nᵢ. In other embodiments, equations (1) and (2) may be multiplied by other constants. Alternatively, the median, the mode, the maximum value, the minimum value, or the like may be used for each zone. Averaging the acoustic emission signals in each time/distance zone may smooth the signal and remove anomalous spikes, jumps, dips, and/or the like from consideration. Removing anomalous signal elements may allow for a closer tolerance on the order of sub-microns.

Each measured signal level 222 may be compared to a corresponding master signal level 232 to determine whether the measured signal level 222 exceeds one or more predetermined tolerance thresholds. In some embodiments, the one or more predetermined tolerance thresholds may be determined as percentages of the plurality of master or learned signal levels 232. For example, the measured signal level 222 may be required to be more than a low threshold of 70% of the master signal level 232 and less than a high threshold of 130% of the master signal level 232. There be multiple high and/or multiple low thresholds in some embodiments with the multiple thresholds representing the extent of error.

The screen displays 200a and 200b may use color codes to indicate whether each measured signal level 222 is within the predetermined tolerance thresholds. For example, a red rectangle 223 may indicate the measured signal level 222 is outside the predetermined tolerance threshold for that time zone. A yellow rectangle 224 may indicate the measured signal level 222 is within the predetermined tolerance threshold for that time zone but is near the predetermined tolerance threshold. Whether the measured signal level 222 is near a predetermined tolerance threshold may be determined using additional thresholds, using absolute or relative comparisons, or the like. A green rectangle 225 may indicate the measured signal level 222 is well within the predetermined tolerance threshold for that time/distance zone.

Because red, yellow, and green may be well known due to their use in traffic signals, the user may be able to readily understand the meaning of the colored rectangles. Thus, a user may be able to qualify each zone quickly and visually. Moreover, the time/distance zones may correspond to known physical locations on the manufactured part 105 or grinding wheel 130, so physical problems may be found quickly based on which time/distance zone is out of tolerance. Differences between the master signal level 232 and the measured signal level 222 may be represented by gray vertical rectangles, varying the shade of the color code, and/or the like.

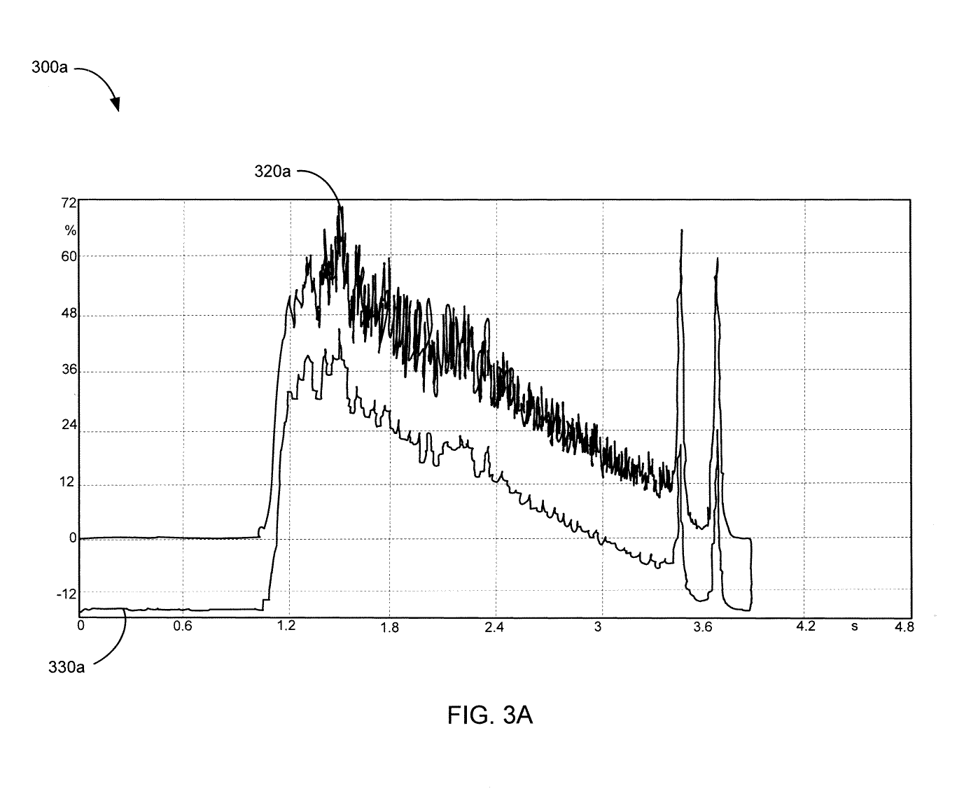

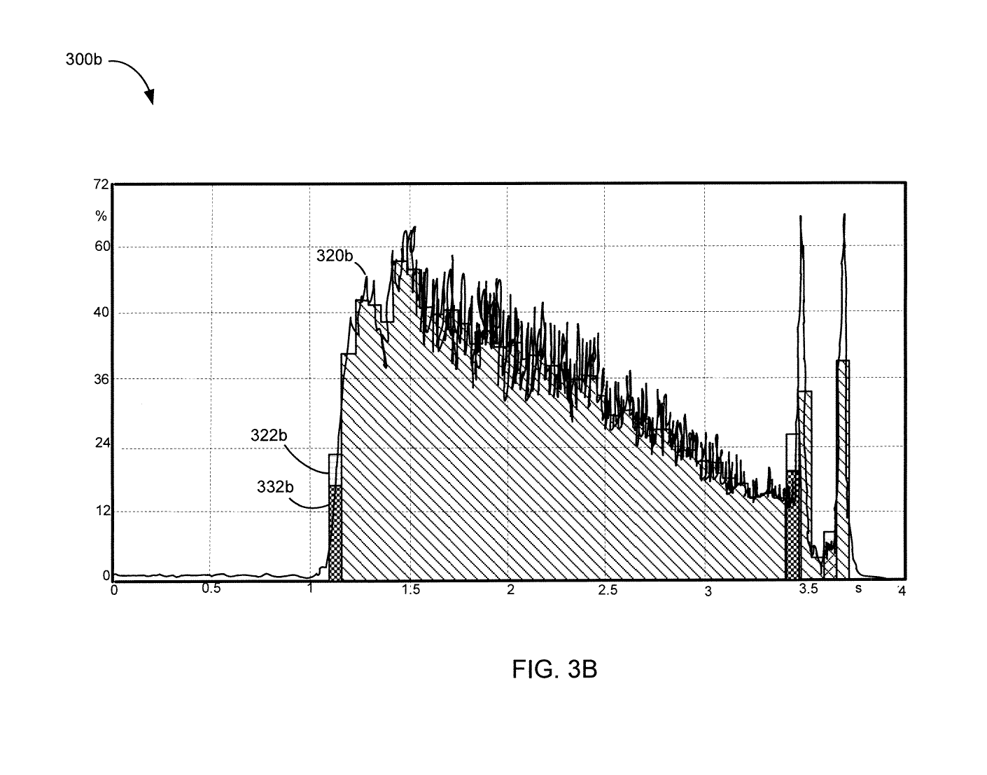

FIGS. 3A-B are exemplary screen displays 300a-b from the monitoring system while monitoring compliance with a lower limit using the Envelope Function method and the Multi-Zone Strategy method. The screen display 300a of the Envelope Function method may comprise a measured signal 320a and a lower threshold 330a. The lower threshold 330a may be created by subtracting a predetermined offset from a previously measured master trace (not shown). In some embodiments, the predetermined offset may be chosen arbitrarily. The subtraction may cause the lower threshold 330a to be negative in some places. In the depicted display, the measured signal 320a is never below the lower threshold 330a, so the monitoring system 150 may indicate the process is good, when in fact it is bad.

The screen display 300b of the Multi-Zone Strategy method may comprise a measured signal 320b, a plurality of measured time/distance zone signal levels 322b, and a plurality of master time/distance zone signal levels 332b. The monitoring system 150 may determine whether any of the plurality of measured time/distance zone signal levels 322b are less than a predetermined percentage of the master time/distance zone signal levels 332b. Green, yellow, and red colored rectangles may be used to indicate the results of the comparison. Sometimes, the Multi-Zone Strategy method may correctly detect out of tolerance zones even though the Envelope Function method indicates the process is good.

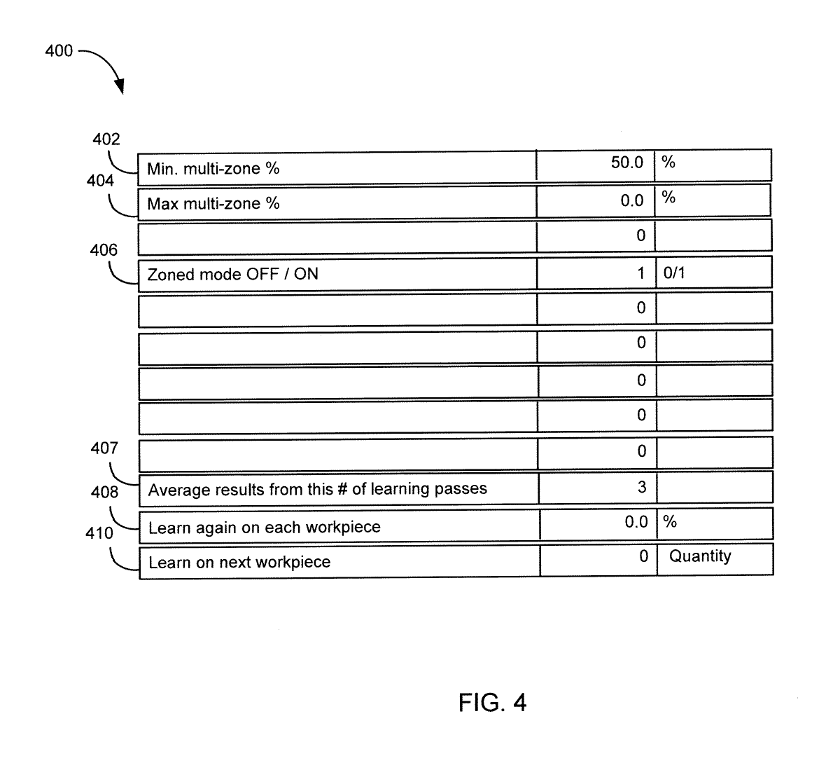

FIG. 4 is an exemplary screen display 400 for setting up the Multi-Zone Strategy method on the monitoring system 150. The user may set a minimum Multi-Zone percentage 402 and a maximum Multi-Zone percentage 404. The minimum Multi-Zone percentage 402 may be a predetermined percentage of the master signal level 332b below which the measured signal levels 322b may not fall. The maximum Multi-Zone percentage 404 may be a predetermined percentage over the master signal level 332b above which the measured signal levels 322b may not rise. The minimum and/or maximum Multi-Zone percentage 402, 404 may be set to zero to turn off comparisons to that threshold. The screen display 400 may further allow the user to select whether or not to enable zoned mode 406. In some embodiments, the user may select 0 or 1 to represent no or yes respectively. The user may average the results of a plurality of passes 407 during the learning cycle to assure the best possible shape of the master signal for the dressing wheel 145 and/or the grinding wheel 130. The user may designate how many passes to average. The user may add a percentage to learn again on each workpiece 408 and an amount to learn on next workpiece 410. In this manner, the cylindrical grinding machine 100 may provide automatic compensation for expected future wear upon the dressing wheel 145 or the grinding wheel 130.

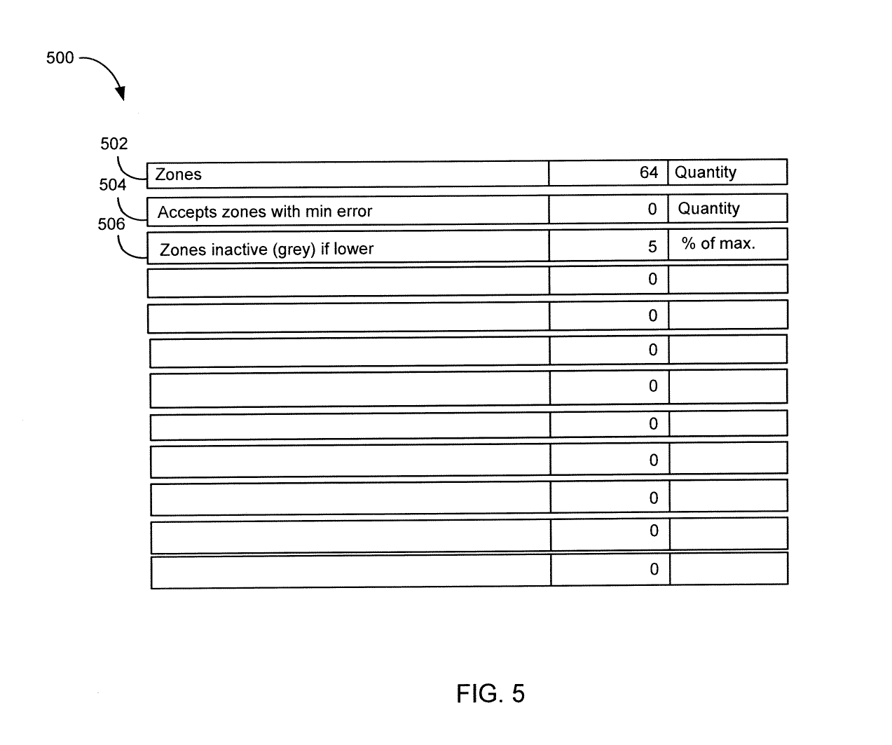

FIG. 5 is an exemplary screen display 500 for further setting up the Multi-Zone Strategy method on the monitoring system 150. The user may select the number of time/distance zones 502 into which to divide the measured signal 220. For equally sized zones, the size of the time/distance periods may be the time/distance for the measured signal 220 divided by the number of time/distance zones 502. A user may also set a quantity 504 of zones with minimal error that may be accepted. Borderline zones with minimal error may then be accepted by the operator by zone.

In some embodiments, certain time/distance zones may be inactive. For example, certain time/distance zones may have abnormal results and/or may not be beneficial for controlling a machining process if included. For the inactive time/distance zones, the monitoring system 150 may not indicate whether the measured acoustic emission signal level 222 for that time/distance zone exceeds the predetermined threshold. In an embodiment, the inactive time/distance zones are turned blue to indicate that they are inactive. In some embodiments, the user may select the particular time/distance zones to be inactive. Once a plurality of master signal levels have been created, the system may display the results to the user. The user may selectively deactivate particular time/distance zones from the final plurality of master signal levels. Alternatively, or in addition, a minimum inactivity threshold 506 may be set. If the master signal level is below the minimum inactivity threshold 506 for a particular time/distance zone, that time/distance zone may be inactive. The minimum inactivity threshold 506 may be specified in absolute units; relative units, such as a percentage of a maximum possible master signal level; or the like. Excluding the inactive time/distance zones from consideration may improve precision and/or accuracy in the control of the machining process.

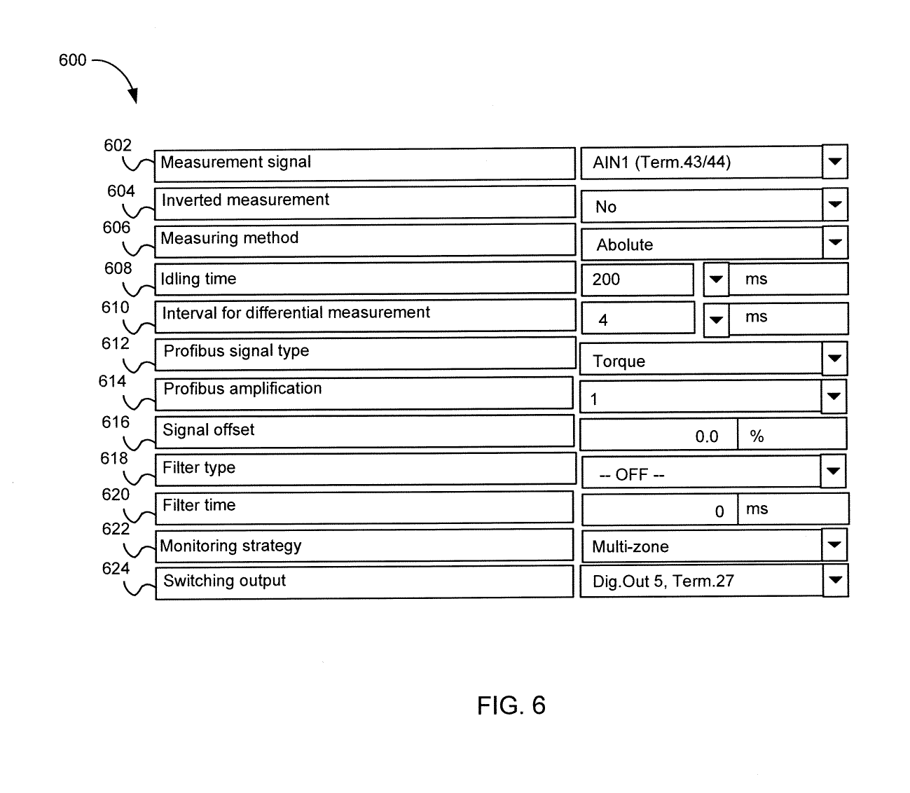

FIG. 6 is an exemplary screen display 600 for setting parameters of measuring equipment, such as the acoustic emission sensor 110. In some embodiments, the monitoring system 150 may be coupled to a plurality of sensors, so the user may select a measurement signal 602 to be monitored. In some embodiments, more than one signal may be selected. The multiple signals may displayed within a single display screen, a plurality of display screens, or the like. The user may also be able to select whether the sensor produces an inverted signal 604 and the measuring method 606, such as absolute, relative, or the like. The y-axis 214 may be flipped for inverted signals, and the scale of the y-axis 214 may be varied based on the measuring method.

A machine computer control system may electronically send a start message to the cylindrical grinding machine 100. An idling time 608 between the sending of the start message and the beginning of data collection may be set. During the idle time, no data is collected, which may allow the electronics to settle. An interval time for differential measurements 610 may also be set. A filter may also be set up. To do so, a user may set a Process Field Bus (PROFIBUS) signal type 612, a PROFIBUS amplitude 614, a signal offset 616, a filter type 618, and a filter time 620.

The user may select the monitor strategy 622 to be used by the monitoring system. The monitoring strategy 622 may comprise the Envelope Function method, the Multi-Zone Strategy method, or the like. The user may also select a switching output 624 in some embodiments. The switching output 624 may allow the monitoring system 150 to terminate an out of tolerance process. Because the monitoring system 150 may be attached to a plurality of machining tools, the switching output 624 may specify a port to which the machining tool of interest is coupled.

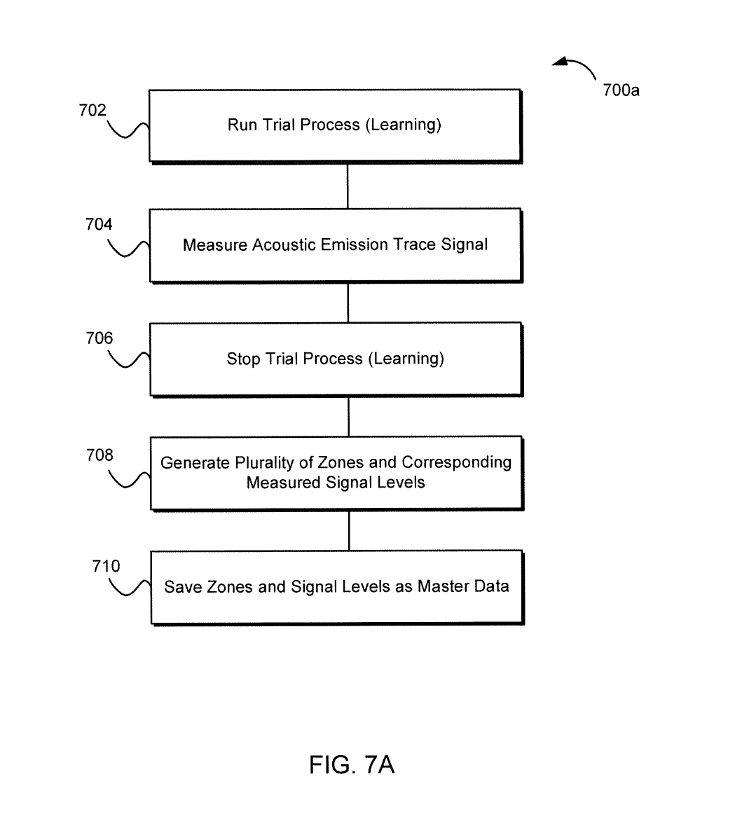

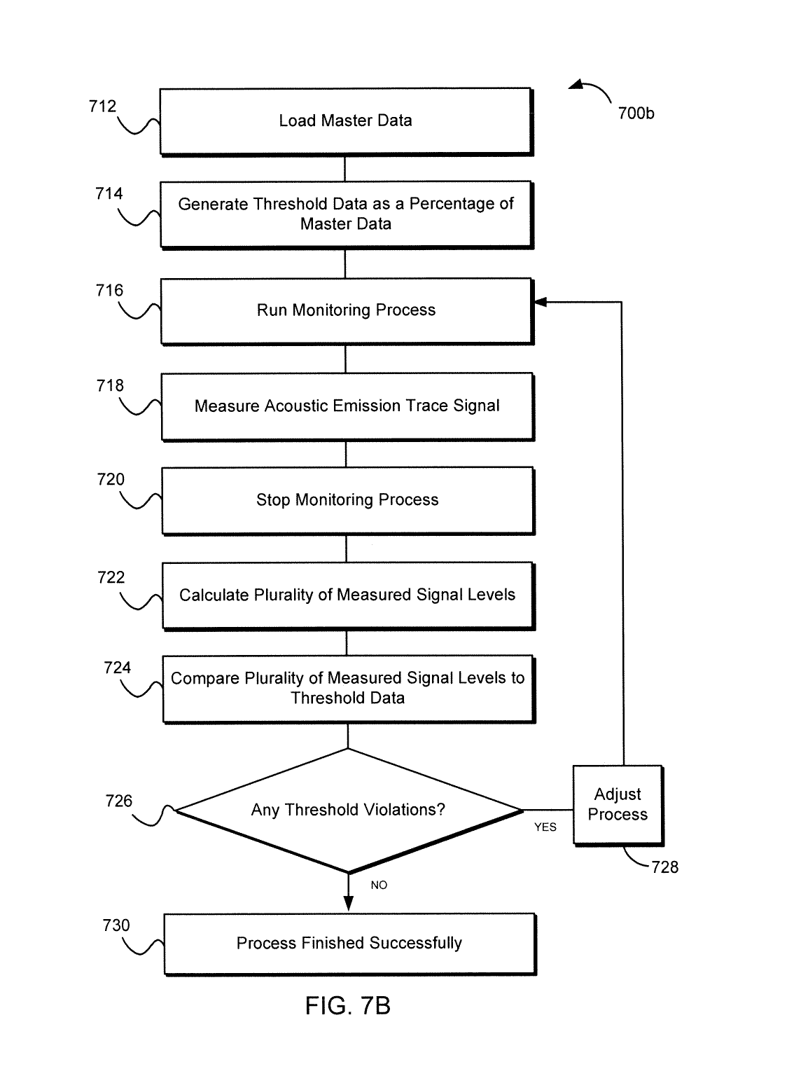

FIGS. 7A-B are flow diagrams of methods 700a-b for creating master data in a learning mode and comparing a measured acoustic emission signal to the master data. For example, a process from a first grinding machine may be repeated and reproduced at a second grinding machine using a master acoustic emission signal from the first grinding machine. Sometimes, the first grinding machine may be located at a different plant or far away from the second grinding machine. Alternatively, as the dressing wheel or grinding wheel is worn and changes, a history file and/or master data may be used to reestablish a correct starting point on the new dressing or grinding wheel, on the same grinding wheel on the same grinding machine, and/or the like.

The method for creating master data 700a may begin with the monitoring system 150 running 702 a trial/learning processes. During the trial/learning process, an acoustic emission sensor may measure 704 an acoustic emission trace signal. The trial process may then be stopped 706. A plurality of zones and measured signal levels may be generated 708 from the acoustic emission trace signal. In some embodiments, a plurality of trial/learning processes may be averaged to improve the accuracy of the results. The zones and signal levels may then be saved 710 as master data for future use. The saved final trial process may be within less than a micron of the desired process. Multiple sets of master signal levels (e.g., multiple pluralities of master signal levels) may be saved in some embodiments. The multiple sets of master signal levels may be for different processes and/or for a multi-step operation.

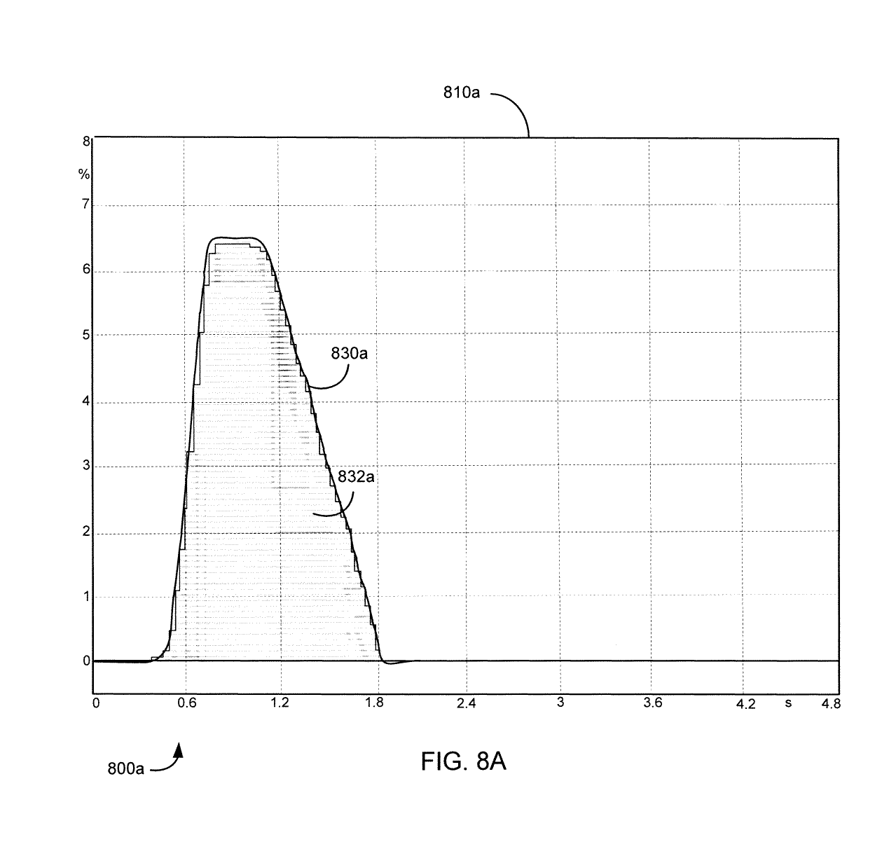

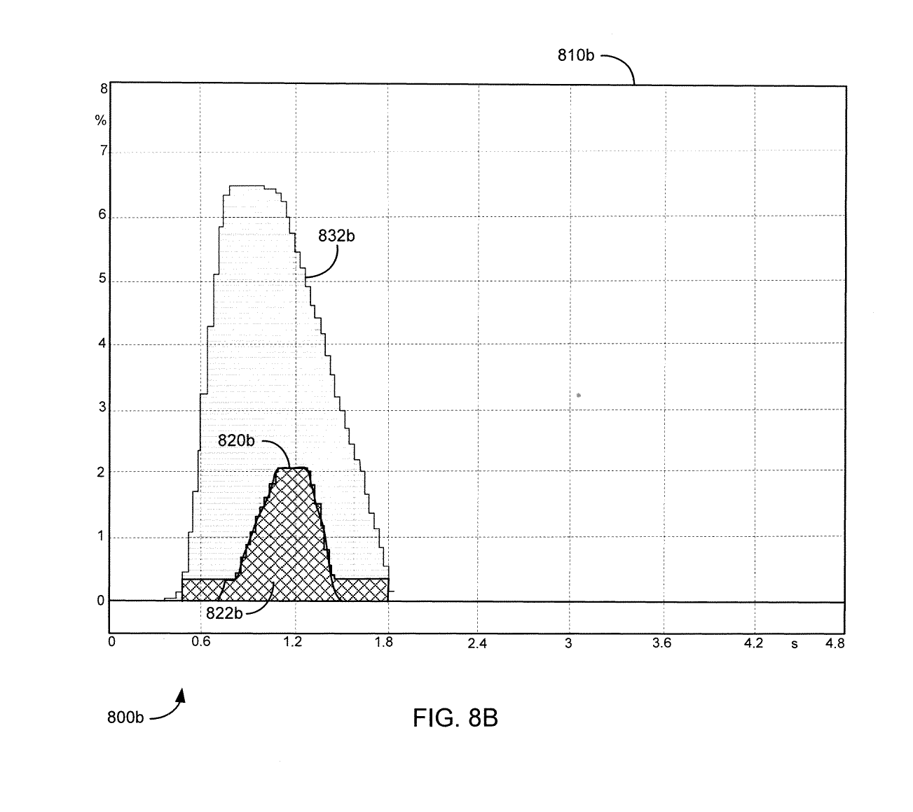

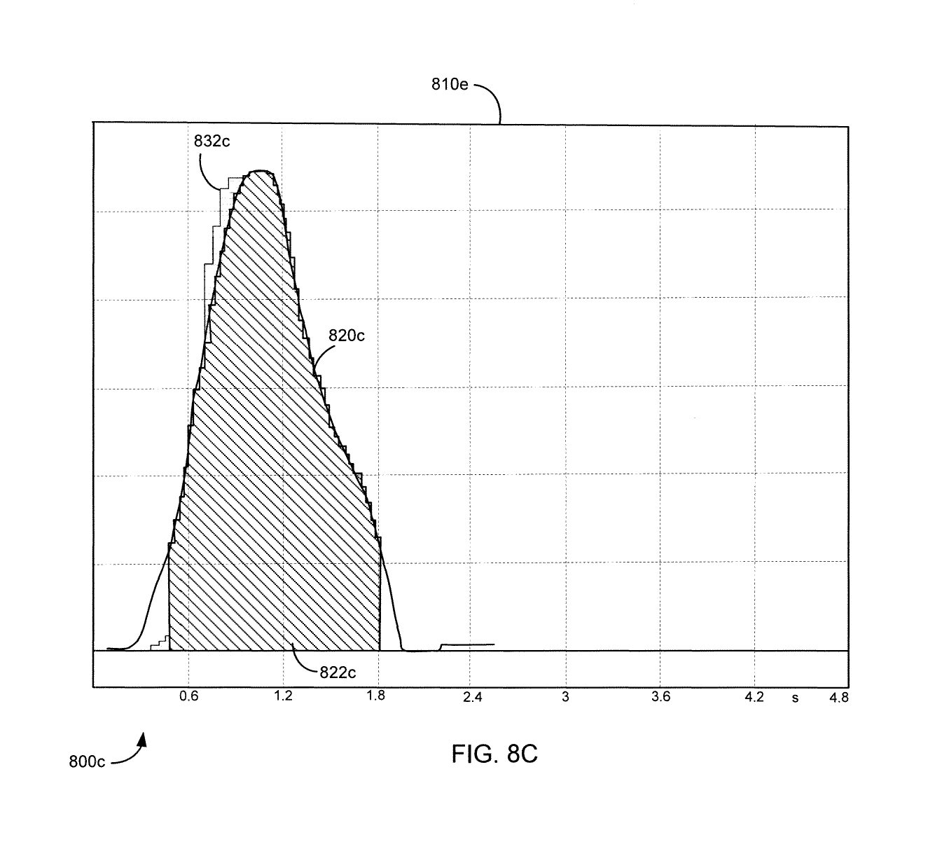

The monitoring system 150 may use a process 700b to compare the master data to a measured signal level and determine whether the measured results are correct. Initially, the master data may be loaded 712. For example, the master data may be saved locally, loaded from a removable media device, loaded from a network, and/or the like. Referring also to FIGS. 8A-C, the master acoustic emission signal trace 830a may be depicted on the exemplary screen display 800a as a line on a graph 810a. The master signal levels 832a-c may be depicted as gray bars on the graphs 810a-c. The monitoring system 150 may generate 714 threshold data as a percentage of the master signal levels. In some embodiments, the thresholds may be 0%, 1%, 5%, 10%, 20%, or the like of the master signals levels. There may be high and/or low thresholds, which need not necessarily be the same percentage.

One or more iterations of a monitoring processes may be run 716 on the cylindrical grinding machine 100. An acoustic emissions trace signal may be measured 718 for each iteration. A measured acoustic emission signal 820b-c for each iteration may be depicted on exemplary screen displays 800b-c as lines on the graphs 810b-c. The monitoring process may be stopped 720 once it has completed. A plurality of measured signal levels 822b-c may be calculated 722 from the measured acoustic emission signal 820b-c.

The plurality of measured signal levels 822b-c may be compared 724 to the plurality of master signal levels 832a-c. The plurality of measured signal levels 822b-c may be depicted as red, yellow, and/or green bars overlaid on the plurality of master signal levels 832a-c. Red may indicate one or more predetermined tolerance thresholds have not been met; yellow may indicate the one or more predetermined tolerance thresholds have barely been met; and green may indicate the plurality of measured signal levels 822b-c are well within the one or more predetermined tolerance thresholds.

The monitoring system 150 may determine 726 whether the measured signal levels violate any of the previously generated thresholds, and/or whether more than a predetermined number of allowable violations have occurred. In some embodiments, the predetermined number of allowable violations may be zero. If more than the predetermined number of allowable violations occurred, the cylindrical grinding machine 100 may adjust 728 the process and run an additional iteration to improve the end results. If the measured signal level 822b-c for a particular time/distance zone is below a tolerance threshold, it may indicate that the grinding or dressing needs to go deeper. In contrast, if the measured signal level 822b-c for a particular time/distance zone is above a tolerance threshold, it may indicated the grinding or dressing is too deep. For each iteration, the depth of the grinding or dressing may be adjusted by a few microns or less. Once no more than the predetermined number of allowable threshold violations have occurred and/or the measured results are within the previously generated high and low thresholds, the process may finish 730 and indicate that it was successful. Thus, the cylindrical grinding machine 100 may be able to repeat and reproduce the desired process in a highly precise manner.

It will be understood by those having skill in the art that many changes may be made to the details of the above-described embodiments without departing from the underlying principles of the disclosure. The scope of the present disclosure should, therefore, be determined only by the following claims.

1. A system for monitoring machining of a workpiece, the system comprising:
a sensor configured to generate a measured signal, wherein the measured signal is correlated to variations in the machining of the workpiece; and
a monitoring system configured to:
calculate a plurality of measured signal levels for a plurality of corresponding contiguous time zones from the measured signal; and
indicate whether each measured signal level at each corresponding time zone is within one or more predetermined thresholds.

2. The system of claim 1, wherein the monitoring system is further configured to:
receive a master signal;
generate a plurality of master signal levels corresponding to the plurality of contiguous time zones; and
save the plurality of master signal levels, wherein the one or more predetermined thresholds for each contiguous time zone are calculated from the plurality of master signal levels.

3. The system of claim 2, wherein the master signal is received from the sensor during a trial/learning process.

4. The system of claim 2, wherein the monitoring system is configured to save multiple pluralities of master signal levels for multiple corresponding processes.

5. The system of claim 1, wherein the one or more predetermined thresholds are generated from a plurality of master signal levels, and wherein the plurality of master signal levels are loaded using a removable media device.

6. The system of claim 1, wherein the monitoring system is configured to disregard the measured signal during one or more inactive time zones.

7. The system of claim 1, wherein the monitoring system is configured to calculate each measured signal level by averaging the measured signal within each corresponding contiguous time zone.

8. The system of claim 1, wherein the sensor is selected from the group consisting of an acoustic emission sensor, a power sensor, and a temperature sensor.

9. The system of claim 1, wherein the workpiece is selected from the group consisting of a manufactured part, a grinding wheel, and a dressing wheel.

10. A computer-implemented method of monitoring machining of a workpiece, the method comprising:
generating a measured signal using a sensor, wherein the measured signal is correlated to variations in the machining of the workpiece;
calculating, with a processor, a plurality of measured signal levels for a plurality of corresponding contiguous time zones from the measured signal; and
indicating whether each measured signal level at each corresponding time zone is within one or more predetermined thresholds.

11. The method of claim 10, further comprising initial steps of:
receiving a master signal;
generating a plurality of master signal levels corresponding to the plurality of contiguous time zones; and
saving the plurality of master signal levels, wherein the one or more predetermined thresholds for each contiguous time zone are calculated from the plurality of master signal levels.

12. The method of claim 11, wherein receiving the master signal comprises receiving the master signal from the sensor during a trial/learning process.

13. The method of claim 11, further comprising saving multiple pluralities of master signal levels for multiple corresponding processes.

14. The method of claim 10, further comprising initial steps of:
loading a plurality of master signal levels using a removable media device; and
generating the one or more predetermined thresholds from the plurality of master signal levels.

15. The method of claim 10, wherein calculating and indicating comprise disregarding the measured signal during one or more inactive time zones.

16. The method of claim 10, wherein calculating each of the plurality of measured signal levels comprises averaging the measured signal within each corresponding contiguous time zone.

17. The method of claim 10, further comprising adjusting a machining process based on whether each measured signal level at each corresponding contiguous time zone is within the one or more predetermined thresholds.

18. The method of claim 10, wherein the sensor is selected from the group consisting of an acoustic emission sensor, a power sensor, and a temperature sensor.

19. The method of claim 10, wherein the workpiece is selected from the group consisting of a manufactured part, a grinding wheel, and a dressing wheel.

20. A non-transitory computer readable storage medium comprising program code configured to cause a processor to perform a method of monitoring machining of a workpiece, the method comprising:
receiving a measured signal from a sensor, wherein the measured signal is correlated to variations in the machining of the workpiece;
calculating a plurality of measured signal levels for a plurality of corresponding contiguous time zones from the measured signal; and
indicating whether each measured signal level at each corresponding time zone is within one or more predetermined thresholds.
